(19) United States
(12) Patent Application Publication
(10) Pub. No.: US 2005/0073599 A1
(43) Pub. Date: Apr. 7, 2005

(54) Low energy consumption imager through operation technique

(75) Inventor: Clay A. Dunsmore, Victor, NY (US)

Correspondence Address: Thomas H. Close;Eastman Kodak Company, Patent Legal Staff, 343 State Street, Rochester, NY, 14650-2201, US

(73) Assignee: Eastman Kodak Company

(21) Appl. No.: 10/677,766

(22) Filed: Oct. 2, 2003

(51) Int. Cl. H04N 3/14; H04N 5/335

(52) U.S. Cl. 348/308; 348/294

(57) ABSTRACT

A CMOS image sensor includes a plurality of pixels each having a photo-sensitive element that receives light that is converted into charge and conversion circuitry that converts the charge into a voltage signal; wherein the plurality of pixels are integrated at substantially a same time; and readout electronics that receives the voltage signal from the conversion circuitry of the plurality of pixels and passes the charge therefrom; wherein the readout electronics are de-energized during substantial integration of the pixels and energized during readout.

### FIELD OF THE INVENTION

The invention relates generally to the field of CMOS image sensors and, more particularly, to such CMOS image sensors having reduced energy consumption by de-energizing the horizontal read-out electronics of the sensor during integration (non-readout time periods).

### BACKGROUND OF THE INVENTION

CMOS image sensors typically include a plurality of pixels each having a photodiode for capturing incident light and adjacent electronics for receiving charge from the photodiode and converting it into a voltage signal, which is subsequently readout. CMOS sensors are integrated by two methods. In one method, “rolling shutter” method, predetermined rows of the sensor are integrated at different, yet sequential, times. For example, the top first two rows are integrated and then the next two rows are integrated and etc. In the “global shuttering method,” all the rows are integrated at substantially the same time.

Although the above-described methods and apparatus are satisfactory, they include a drawback. In this regard, the horizontal readout electronics, which receives the voltage signals from the rows of pixels, are continuously on so that power is continuously consumed.

Consequently, a need exists for overcoming the above-described drawback of continuous power consumption.

### SUMMARY OF THE INVENTION

The present invention is directed to overcoming one or more of the problems set forth above. Briefly summarized, according to one aspect of the present invention, the invention resides in a CMOS image sensor having a plurality of pixels each having a photo-sensitive element that receives light that is converted into charge and conversion circuitry that converts the charge into a voltage signal; wherein the plurality of pixels are integrated at substantially a same time; and readout electronics that receives the voltage signal from the conversion circuitry of the plurality of pixels and passes the charge therefrom; wherein the readout electronics are de-energized during substantial integration of the pixels and energized during readout.

These and other aspects, objects, features and advantages of the present invention will be more clearly understood and appreciated from a review of the following detailed description of the preferred embodiments and appended claims, and by reference to the accompanying drawings.

### ADVANTAGEOUS EFFECT OF THE INVENTION

The present invention has the advantage of reducing power consumption by de-energizing the horizontal readout electronics during non-readout time periods.

### BRIEF DESCRIPTION OF THE DRAWINGS

FIG. 1 is a top view of a CMOS image sensor having a plurality of pixels;

FIG. 2 is a schematic diagram of an individual pixel; and

FIG. 3 is a perspective view of a digital camera for implementing a commercial embodiment of the image sensor of FIG. 1.

### DETAILED DESCRIPTION OF THE INVENTION

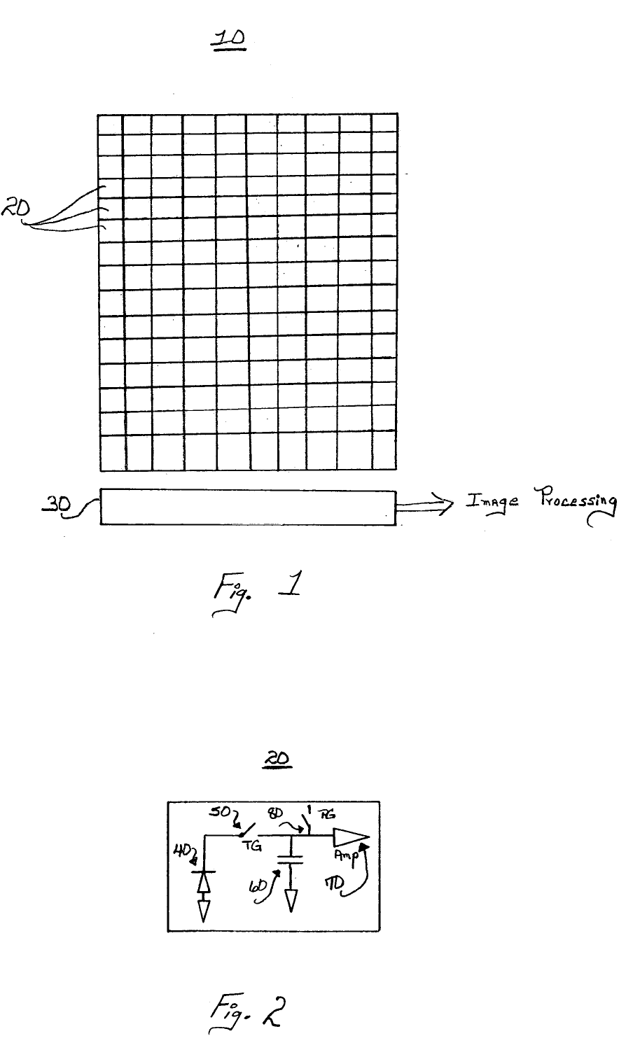

Referring to FIG. 1, there is shown a top view of a CMOS image sensor 10 of the present invention. The sensor 10 includes a plurality of pixels 20 for forming an electronic representation of an image and horizontal readout electronics 30 that receives a voltage signal from the plurality of pixels 20. The horizontal readout electronics 30 then passes the charge serially to image processing electronics for subsequent processing.

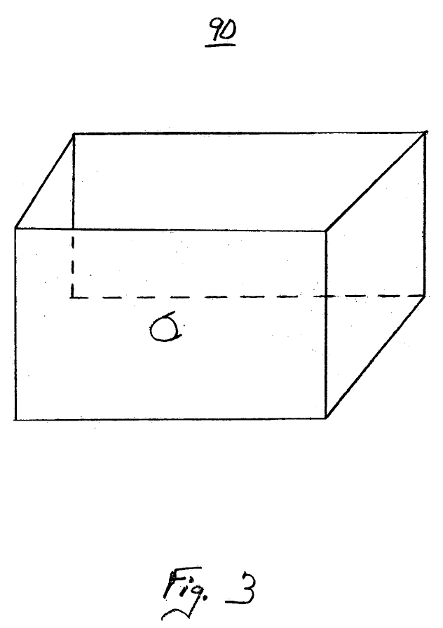

The sensor 10 of the present invention includes global shuttering so that all the pixels 20 are exposed substantially simultaneously. Global shuttering can be performed by any of a variety of well-known mechanisms, as is well known in the art. In this regard, and referring briefly to FIG. 2, each pixel 20 includes a photodiode 40 for capturing incident light that is converted into a charge. It is reiterated for clarity of understanding that the capturing of charge or integration time is substantially the same (global shuttering or non-rolling shuttering) for all the pixels 20. A transfer gate (TG) 50 is then closed for selectively transferring the charge to a capacitor 60. The charge on the capacitor 60 is then selectively passed to an amplifier 70, which converts the charge into a voltage signal. After readout, a reset transistor 80 resets the charge on the capacitor 60 to a predetermined level.

Referring back to FIG. 1, the horizontal readout electronics 30 is selectively energized for receiving the charge from the pixels 20. During integration or exposure to light, the horizontal readout electronics 30 is de-energized for conserving power, and after integration and during read out, the horizontal readout electronics 30 is energized for receiving the voltage signal from the pixels in a row-by-row manner. For example, the first row is read out and then the second row is read out and etc.

Referring to FIG. 3, there is shown a digital camera 90 for implementing a commercial embodiment of the present invention to which an ordinary consumer is accustomed.

The invention has been described with reference to a preferred embodiment. However, it will be appreciated that variations and modifications can be effected by a person of ordinary skill in the art without departing from the scope of the invention.

### Parts List

10 CMOS image sensor
20 pixels
30 horizontal readout electronics
40 photodiode
50 transfer gate
60 capacitor
70 amplifier
80 reset gate
90 digital camera

1. A CMOS image sensor comprising:
(a) a plurality of pixels each having a photo-sensitive element that receives light that is converted into charge and conversion circuitry that converts the charge into a voltage signal; wherein the plurality of pixels are integrated at substantially a same time;
(b) readout electronics that receives the voltage signal from the conversion circuitry of the plurality of pixels and passes the charge therefrom; wherein the readout electronics are de-energized during substantial integration of the pixels and energized during readout.

2. The CMOS image sensor as in claim 1, wherein the readout electronics is a horizontal output CCD.

3. A digital camera comprising:
(a) a CMOS image sensor comprising:
(a1) a plurality of pixels each having a photo-sensitive element that receives light that is converted into charge and conversion circuitry that converts the charge into a voltage signal; wherein the plurality of pixels are integrated at substantially a same time;
(a2) readout electronics that receives the voltage signal from the conversion circuitry of the plurality of pixels and passes the charge therefrom; wherein the readout electronics are de-energized during substantial integration of the pixels and energized during readout.

4. The digital camera as in claim 3, wherein the readout electronics is a horizontal output CCD.
